(19) United States
(12) Patent Application Publication
(10) Pub. No.: US 2009/0183914 A1
(43) Pub. Date: Jul. 23, 2009

(54) Electrical Guide Section for Cable Leadthroughs

(75) Inventor: Alexander Urgatz, Leverkusen (DE)

Correspondence Address: BROMBERG & SUNSTEIN LLP, 125 SUMMER STREET, BOSTON, MA, 02110-1618, US

(73) Assignee: Auto Kabel Managementgesellschaft mbH, Hausen i.W. (DE)

(21) Appl. No.: 12/301,323

(22) PCT Filed: May 18, 2006
(86) PCT No.: PCT/EP2006/062410

§ 371 Date: Dec. 12, 2008

(51) Int. Cl. H02G 3/18

(52) U.S. Cl. 174/668

(57) ABSTRACT

The application relates to an electrical guide section for feeding a motor vehicle cable through a wall of a motor vehicle, with a first connection for a power cable and a second connection for a power cable. A cable feedthrough of small construction space and easy to install can be achieved, in that the electrical guide section between the first connection and the second connection has an offset element which makes feeding of the cable through the housing possible, and in that the electrical guide section has a mounting for a securing device in such a manner that the securing device can be pushed into the mounting in order to secure the electrical guide section to the wall.

The application relates in general to an electrical guide section for feeding a motor vehicle cable through a wall in a motor vehicle, in particular a motor vehicle body sheet metal, with a first connection for a current cable and a second connection for a current cable. The application further relates to a securing device for securing such an electrical guide section to a wall, in particular a body sheet metal, of a motor vehicle. The application also relates to a system for securing an electrical guide section to a wall of a motor vehicle and to a method for this.

The electrical supply of components in motor vehicles is growing in importance. An ever greater number of components inside motor vehicles are being powered by electrical energy. For this purpose it is necessary for energy conductors to be arranged such as to branch out widely in the body of the vehicle. It is usual for the battery cable harnesses to be laid in the underbody or in the central channel of a motor vehicle. To establish the contact to components inside the vehicle it is therefore frequently necessary for the cables to be fed through sheet metal or other walls inside the vehicle.

In order to provide tapping or pick-up points on battery cables, use is made of what are referred to as transfer support posts. With the use of flat conductors for battery leads it is then usual for these transfer support posts to be formed by bolts arranged on the flat conductor. To provide the contact, the bolts are pushed through holes into the flat conductors. By means of a screw connection with a sleeve the bolts are then connected by non-positive fit to the flat conductor.

A disadvantage with the known electrical guide sections for feeding cables through a motor vehicle housing, however, is the fact that the screwing of the sleeve onto the bolt requires an enlarged construction and assembly space. In addition, the time required for screwing on the sleeves is substantial. Finally, the screwed sleeves may become detached due to vibrations.

The object of the application is therefore to make available an electrical guide section, a securing device, a system and method for securing an electrical guide section to a wall of a motor vehicle, which is economical, takes up little construction space, and is easy to install.

The object outlined previously and derived from the prior art is resolved by an electrical guide section in which the electrical guide section between the first connection and the second connection has an offset element which makes feeding of the cable through the housing possible, and in which the electrical guide section has a mounting for a securing device, in such a manner that the securing device can be pushed into the mounting in order to secure the electrical guide section to the housing.

The electrical guide section is shaped by the offset element in such a way that it allows a cable to be fed through a motor vehicle body sheet metal. Here, located on each side of the sheet metal is a connection element for the electrical guide section. In order to secure the electrical guide section it is proposed that it be fixed to the wall by means of a securing device. To achieve this, according to the invention the securing device is pushed into the mounting by a transversal movement.

By pushing the securing device into the mounting, the construction space can be kept small. No threads are necessary onto which a sleeve needs to be screwed. The electrical guide section can be nestled close to the housing on both sides of the feedthrough. Only in the offset element itself, i.e. at the feed through point, is a mounting necessary into which the securing device can be pushed. Pushing the securing device into position during installation is particularly simple, which substantially reduces installation times. The number of components used is substantially less than with conventional solutions, since apart from the electrical guide section only a securing device is required. There is no longer any need for a bolt, or for a sleeve screwed onto it.

According to an advantageous embodiment, it is proposed that the offset element be step-shaped. This means that the offset element has a projection in the electrical guide section. This offset element is designed in such a way that it fits into the aperture in the vehicle wall for the cable feedthrough. The height of the offset element is selected in such a way that the electrical guide section nestles snug against the vehicle wall, but nevertheless there is a mounting for the securing device.

In order to guarantee good fixing of the electrical guide section to the vehicle wall, it is proposed that the mounting is essentially arranged in the offset element. In this case, fixing the electrical guide section to the vehicle wall can be effected directly at the offset element. This guarantees a non-positive connection between the electrical guide section and the vehicle wall.

It is preferred for the electrical guide section to be arranged in a passage aperture in the wall.

It is also preferred for the mounting to be a passage aperture in the electrical guide section. In this case, the securing device can be pushed through the aperture of the mounting. This accordingly makes it possible for the securing device to be engaged at the electrical guide section. This can be made possible by the appropriate design of the securing device.

A particularly simple and secure assembly arrangement is achieved if the mounting runs essentially parallel to the surface of the housing. In this case, the securing device can be pushed into the mounting parallel to the surface of the wall. For example, the mounting is designed in such a way that it closes flush to the surface of the wall, such that, when the securing device is pushed into the mounting, the electrical guide section lies in contact with the wall of the motor vehicle.

To achieve this, it is also proposed that the mounting be arranged in such a way that, after the securing device has been pushed in, the electrical guide section is in close contact with the housing. In this case, the mounting is designed preferably in such a way that its inner profile corresponds with the outer profile of the securing device, in particular with the part of the securing device which is to be pushed into the mounting.

By pushing the securing device into the mounting, the electrical guide section is pushed onto the wall on the other side. When the securing device is pushed into the mounting, a force is exerted into the electrical guide section perpendicular to the pushing direction, such that it is pushed firmly against the wall.

For connecting power cables it is proposed that a cable shoe be arranged at least one connection. This cable shoe can be welded or soldered to the electrical guide section. Other connections are possible, by positive, non-positive, and/or metallurgical joining. It is also possible for the cable shoe to be formed as one piece from the electrical guide section. The cable shoe can be formed as a crimp shoe. In addition, the cable shoe can be formed in such a way that the power cables can be arranged on it by means of friction welding or ultrasonic welding.

In order to match different structural conditions, it is proposed that the first connection and the second connection enclose an angle directly at the offset element. As a result of this the direction of extension of the electrical guide section at the offset location can be changed.

It is also possible for the profile to be shaped in such a way that the securing device engages between a connection and the housing, wherein the other connection comes in contact with the housing on the side of the housing located opposite the securing device. The angle enclosed by the connections can be between 0 and 180°. Preferably it is an acute angle. It is also possible for the connections to run in opposed directions, such that they are arranged parallel to one another on opposing sides of the housing.

In order to absorb the force normal to the insertion direction exerted by the securing device, it is proposed that the electrical guide section has a support surface. This support surface is preferably arranged on the side of the electrical guide section which does not accommodate the securing device. When the securing device is pushed into the mounting, the normal force can be absorbed by the support surface. The support surface is preferably larger than the passage aperture in the wall. Thanks to the support surface it is guaranteed that, when securing is effected with the securing means, at least the support surface is in contact with the housing. The support surface can also be provided with O-rings, such that sealing of the passage aperture can be effected at least from one side. If, for example, the support surface is arranged on an outer side, and the securing device is pushed onto the inner side of the wall, the housing is essentially sealed by the sealing ring against environmental influences.

In order to simplify the assembly of the electrical guide section, it is proposed that an engagement lug be arranged at the first connection and support surface respectively, in such a way that, when the electrical guide section is pushed into an aperture in the wall, the engagement lug engages at the wall. The engagement lug is shaped in such a way that it is arranged in the outer area of the support surface. If the fitter pushes the electrical guide section into the aperture in the sheet metal, the engagement lug guarantees the preliminary engagement of the electrical guide section to the sheet metal. The securing device can then be pushed into the mounting. It is preferred if the engagement lug and the outer diameter of the offset element have a distance interval between them which approximately corresponds to the diameter of the aperture in the wall. Specifically, this will guarantee that the engagement by the engagement lug with the sheet metal is mounted by a thrust bearing, in this case the outer surface of the projection.

In order to prevent contact between the electrical guide section and the wall, it is proposed that the electrical guide section be provided with insulation cladding between the first connection and the second connection. This insulation cladding can, for example, be an extrusion-coating application. The insulation cladding can in this situation include the entire surface of the electrical guide section, with the exception of the outer connections.

It is preferred if the first connection or the second connection is a flat conductor.

A further aspect of the application is a securing device for securing an electrical guide section, described previously, to a wall of a motor vehicle with at least two fingers, wherein a first finger is formed in such a way that it can be pushed into the mounting of the electrical guide section, and wherein a second finger is located at a distance from the first finger in such a way that in the inserted state it is in close contact with the offset element.

An end position of the securing device in the inserted state is formed by a surface of the offset element. When the securing device is pushed into the mounting, it is in contact with the offset element with its fingers.

It is further preferred for the first finger to taper in the insertion direction, in such a way that in the inserted state the first finger is in close contact on the inner walls of the mounting. The first finger is shaped in such a way that at the beginning of the insertion it fits easily into the mounting. As the insertion depth increases, the profile of the finger comes closer to the inner profile of the mounting, and in the inserted state the first finger is in close contact with the inner walls of the mounting.

If the lower base of the mounting e.g. the support surface lies below the level of the wall, the pushing in movement exerts a normal force onto the electrical guide section. This has the effect of the electrical guide section coming in close contact with the wall with its support surface.

In order to prevent changes of position of the securing device in the mounting, it is also proposed that the width of the first finger essentially corresponds to the width of the mounting.

According to an advantageous embodiment, it is proposed that a further finger be arranged next to the first finger, wherein the further finger has an engagement lug in such a way that in the inserted state the engagement lug engages behind the mounting, such that the securing device is engaged at the electrical guide section.

In order to prevent the electrical guide section from inclining towards the passage aperture, it is also proposed that the further finger in the inserted state is arranged between the wall and the second connection. The second connection can be arranged at the offset element in such a way that an intermediate space is formed between the wall and the second connection. The further finger can engage into this intermediate space. By means of this engagement the second connection can be supported at the wall. In this case it is particularly preferred if the height of the further finger corresponds approximately to the distance interval between the wall and the second connection.

A further aspect of the application is a system for securing an electrical guide section to a wall of a motor vehicle with an electrical guide section as described previously and a securing device as described previously.

An additional aspect of the application is a method for securing an electrical guide section to a housing of a motor vehicle, in which an electrical guide section as described previously is pushed into a feedthrough aperture of the housing, such that an offset element of the electrical guide section is arranged in the feedthrough aperture, and in which a securing means as described previously is pushed into the mounting of the electrical guide section by means of a transversal movement, such that the electrical guide section is connected by non-positive fit to the housing.

The application is explained in greater detail hereinafter on the basis of drawings showing an embodiment. In the drawings show:

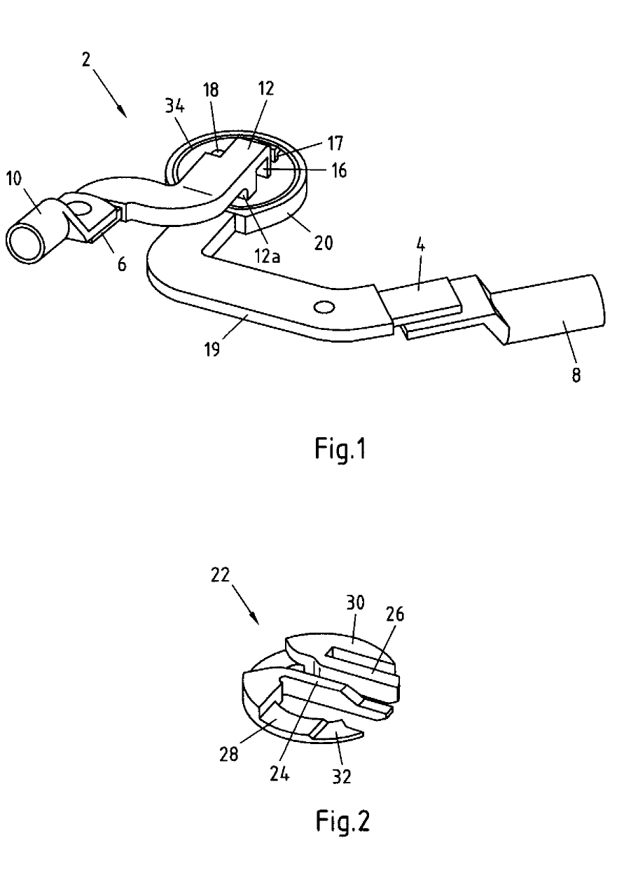

FIG. 1 An exemplary view of an electrical guide section;

FIG. 2 An exemplary view of a securing device;

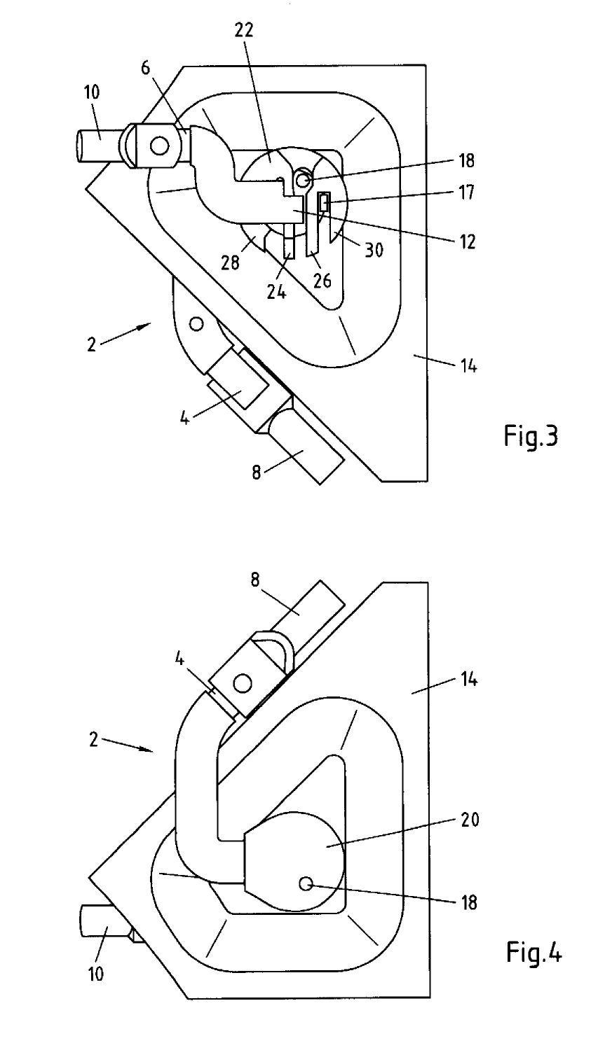

FIG. 3 A view from above of a securing system in the secured state;

FIG. 4 A view from below of a securing system in the secured state;

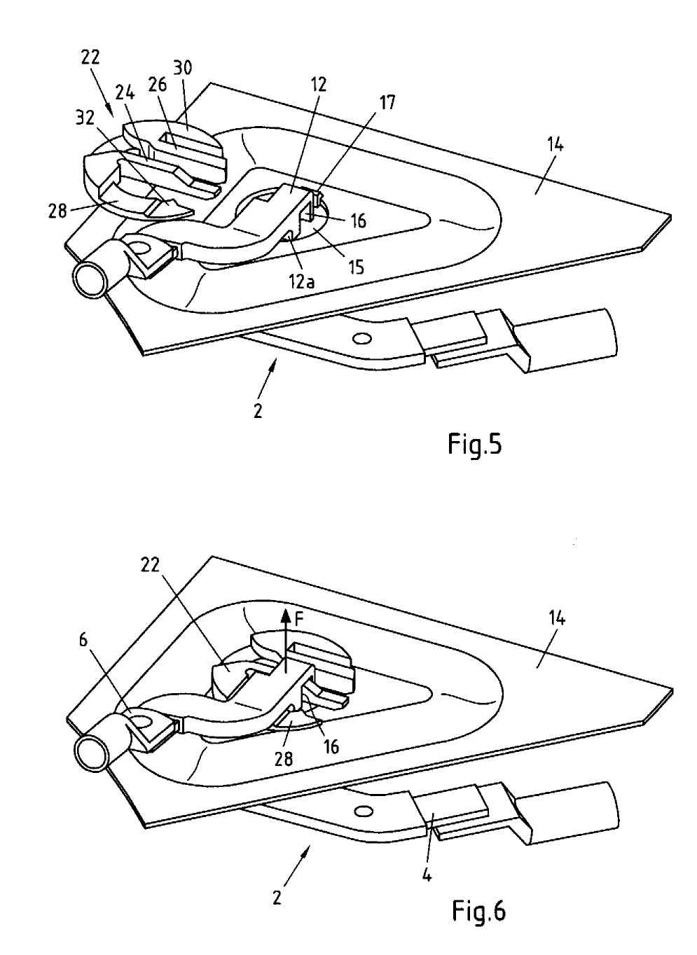

FIG. 5 A view of a system in the non-secured state;

FIG. 6 A view of a system in the secured state.

FIG. 1 shows an electrical guide section 2 with a first connection 4 and a second connection 6. Secured to the first connection 4 is a cable shoe 8. Arranged at the second connection 6 is a further cable shoe 10. Provided between the first connection 4 and the second connection 6 is an offset element 12 in the electrical guide section 2. The offset element 12 is step-shaped, such that the connection 4 and the connection 6 lie on different planes. The offset element 12 is shaped in such a way that a motor vehicle sheet metal 14 can be arranged between the first connection 4 and the second connection 6. Provided in the offset element 12, is a mounting 16 as a passage aperture. The mounting 16 is arranged in the offset element 12 in such a way that it lies essentially above the plane of the motor vehicle sheet metal 14 on the side of the second connection 6.

The electrical guide section 2 is insulated by insulation cladding 19. At the ends of the connections 4, 6, at which the cable shoes 8, 10 are arranged, the metallic core of the electrical guide section 2 is exposed. The cable shoes 8, 10 can be connected to the electrical guide section 2 by means, i.e. of soldering or welding so as to be metallurgically joined, or formed directly from the connections 4, 6.

A ventilation aperture 18 is provided in the immediate vicinity of the offset element 12. A ventilation hose for ventilating the battery can be pushed through the ventilation aperture 18.

In addition, an engagement lug 17 is also provided. The distance interval between the engagement lug 17 and the outer edge of the offset element 12 is selected in such a way that this approximately corresponds to the size of the passage hole in the sheet metal 14. During assembly and installation the engagement lug 17 enables preliminary engagement of the electrical guide section at the sheet metal such that the fitter, when pushing in the securing device, no longer has to hold the electrical guide section himself.

FIG. 2 shows a securing device 22. The securing device 22 has a first finger 24, a second finger 26, a third finger 28, and a fourth finger 30.

The fingers 24-30 extend parallel to one another. The first finger 24 tapers, starting from the base surface of the securing device 22 in the insertion direction. The tapering can be ramp-shaped. The profile of the first finger 24 corresponds, at least in the vicinity of the base surface, to the inner profile of the mounting 16.

The second finger 26 runs parallel and at a distance to the first finger 24. The intermediate space between the first finger 24 and the second finger 26 corresponds approximately to the width of the bar between the outer surface of the offset element 12 and the inner surface of the mounting 16.

The third finger 28 is formed flatter than the first finger 24 and the second finger 26. The third finger 28 has at its end an engagement lug 32. The third finger 28 engages behind the offset element 12 in such a way as to guarantee an engagement.

Finally, provision is made for a fourth finger 20, which is arranged next to the second finger 26. The intermediate space between the fourth finger 30 and the second finger 26 can be shaped in such a way that it accommodates the engagement lug 34, such that it does not impede the securing arrangement.

FIG. 3 shows the securing system in a secured state. The securing device 22 is pushed into the mounting 16 of the offset element 12. The first finger 24 engages through the mounting 16. The securing device 22 lies between the first finger 24 and the second finger 26, close to the offset element 12. The third finger 28 lies between the motor vehicle sheet metal 14 and the second connection 6. The engagement lug 32 engages behind the offset element 12, such that the securing device 22 engages at the electrical guide section 2. The engagement lug 17 is engaged at the sheet metal 14 and provided with thrust bearing by the outer surface of the offset element 12, which is anchored to the inner diameter of the hole in the sheet metal 14.

FIG. 4 shows the securing system in a view from below. Shown are the motor vehicle sheet metal 14, the first connection 4, and the second connection 6, and the support surface 20. Also indicated is the ventilation aperture 18. The support surface 20 makes it possible for the electrical guide section 2 to be connected in non-positive fit to the motor vehicle sheet metal 14.

FIG. 5 shows a view of a securing system. In the view shown, the securing device 22 is not yet pushed into the mounting 16. It can be seen that the engagement lug 17 is engaged at the motor vehicle sheet metal 14. The outer surface 12a of the offset element 12 is located directly at the inner diameter of the hole 15 in the sheet metal 14. As a result, the engagement lug 34 is provided with a thrust bearing and can engage through the sheet metal 14. This primary engagement guarantees assistance in assembly and installation.

The electrical guide section 2 is inserted through the hole 15. It can further be seen that the motor vehicle sheet metal 14 is formed in trough shape in the area of the hole 15. As a result, the entire construction space can be kept small. The securing device 22 can as a result be pushed into the mounting 16 with no problem.

FIG. 6 shows the securing system with the securing device 22 in the inserted state. The securing device 22 is pushed entirely into the mounting 16. The third finger 28 lies between the second connection 6 and the motor vehicle sheet metal 14.

Due to pushing the securing device 22 into the mounting 16, a force F is exerted perpendicular to the plane of the first connection 4 onto the electrical guide section 2. As a result of this force F the profile 2 is pushed with its support surface 20 onto the motor vehicle sheet metal 14. As a result, a seal can be created by the sealing rings 19 at the support surface 20.

In accordance to the system described, with small construction space, an economical and easy to install cable feedthrough can be produced. A transfer support post can therefore easily be established. Battery cables can be secured to the cable shoes 8, 10 by suitable methods.

1-24. (canceled)

25. An electrical guide section for feeding a motor vehicle cable through a wall in a motor vehicle, the electrical guide section comprising:
a first connection for a cable;
a second connection for a cable;
an offset element between the first connection and the second connection by which the cable is fed through the wall;
a securing device; and
a mounting for the securing device, such that the securing device can be pushed into the mounting in order to secure the electrical guide section to the wall.

26. An electrical guide section according to claim 25, wherein the securing device can be pushed into the mounting parallel to the surface of the wall.

27. An electrical guide section according to claim 25, wherein the securing device can be pushed into the mounting by a transversal movement.

28. An electrical guide section according to claim 25, wherein the offset element is step-shaped.

29. An electrical guide section according to claim 25, wherein the mounting is essentially arranged in the offset element.

30. An electrical guide section according to claim 25, wherein the electrical guide section is arranged in a passage aperture in the wall.

31. An electrical guide section according to claim 25, wherein the mounting is a passage aperture in the electrical guide section.

32. An electrical guide section according to claim 25, wherein the mounting runs essentially parallel to the surface of the wall.

33. An electrical guide section according to claim 25, wherein the mounting is arranged in such a way that, after the securing device has been pushed in, the electrical guide section is in close contact with the wall.

34. An electrical guide section according to claim 25, wherein a cable shoe is arranged at at least one connection.

35. An electrical guide section according to claim 25, wherein the first connection and the second connection enclose an angle directly at the offset element.

36. An electrical guide section according to claim 30, wherein the electrical guide section has a support surface which is larger than the passage aperture in the wall, in such a way that, on securing with the securing means, at least the support surface is in contact with the wall.

37. An electrical guide section according to claim 25, wherein an engagement lug is arranged at the first connection, in such a way that, when the electrical guide section is pushed into an aperture in the wall, the engagement lug engages at the wall.

38. An electrical guide section according to claim 25, wherein the electrical guide section is provided with insulation cladding between the first connection and the second connection.

39. An electrical guide section according to claim 25, wherein the first connection and/or the second connection is a flat conductor.

40. An electrical guide section according to claim 25, wherein the securing device comprises at least two fingers, wherein a first finger is formed in such a way that it can be pushed into the mounting of the electrical guide section, and wherein a second finger is located at a distance interval from the first finger in such a way that in the inserted state it is in close contact with the offset element.

41. An electrical guide section according to claim 40, wherein the securing device further comprises an intermediate space formed between the first finger and the second finger in such a way that in the inserted state the pin engages into the intermediate space.

42. An electrical guide section according to claim 40, wherein the securing device further comprises a first finger that tapers in the insertion direction in such a way that the first finger in the inserted state is in close contact with the inner walls of the mounting.

43. An electrical guide section according to claim 40, wherein the securing device further comprises a first finger that corresponds essentially to the width of the mounting.

44. An electrical guide section according to claim 40, wherein the securing device further comprises a third finger arranged next to the first finger, wherein the third finger has an engagement lug, in such a manner that the engagement lug in the inserted state engages behind the mounting, such that the securing device is engaged at the electrical guide section.

45. An electrical guide section according to claim 44, wherein the securing device further comprises a third finger that in the inserted state is arranged between the wall and the second connection.

46. An electrical guide section according to claim 44, wherein the securing device further comprises a third finger having a height that corresponds approximately to the distance interval between the wall and the second connection.

47. A system for securing an electrical guide section to a wall of a motor vehicle, the system comprising:
a first connection for a cable;
a second connection for a cable;
an offset element between the first connection and the second connection by which the cable is fed through the wall;
a securing device; and
a mounting for the securing device, such that the securing device can be pushed into the mounting in order to secure the electrical guide section to the wall;
wherein the securing device comprises at least two fingers, wherein a first finger is formed in such a way that it can be pushed into the mounting of the electrical guide section, and wherein a second finger is located at a distance interval from the first finger in such a way that in the inserted state it is in close contact with the offset element.

48. A method for securing an electrical guide section to a wall of a motor vehicle, comprising the steps of:
providing an electrical guide section according to claim 25;
pushing the electrical guide section into a passage aperture of the wall, such that the offset element of the electrical guide section is arranged in the passage aperture; and
pushing the securing means into the mounting of the electrical guide section by a transversal movement, such that the electrical guide section is connected by non-positive fit to the wall.
